(19) United States
(12) Patent Application Publication
(10) Pub. No.: US 2006/0251179 A1
(43) Pub. Date: Nov. 9, 2006

(54) Ethernet bridge

(75) Inventor: Sajol Ghoshal, El Dorado Hills, CA (US)

Correspondence Address: KOESTNER BERTANI LLP, 18662 MACARTHUR BLVD, SUITE 400, IRVINE, CA, 92612, US

(73) Assignee: Akros Silicon, Inc.

(21) Appl. No.: 11/448,922

(22) Filed: Jun. 6, 2006

Related U.S. Application Data
(63) Continuation-in-part of application No. 11/207,595, filed on Aug. 19, 2005.
(63) Continuation-in-part of application No. 11/207,602, filed on Aug. 19, 2005.
(60) Provisional application No. 60/665,766, filed on Mar. 28, 2005.

(51) Int. Cl. H04L 25/00

(52) U.S. Cl. 375/257

(57) ABSTRACT

In a network device, an Ethernet bridge module is integrated onto a single-chip integrated circuit. The Ethernet bridge module comprises a network connector integrated onto the Ethernet bridge module in a configuration that transfers power and communication signals, and at least one driver and/or transceiver integrated onto the Ethernet bridge module and configured to interface to at least one device external to the Ethernet bridge module. The Ethernet bridge module further comprises a Power-over-Ethernet (PoE) circuit integrated onto the Ethernet bridge module and coupled between the network connector and the at least one driver and/or transceiver.

### CROSS REFERENCE TO RELATED APPLICATIONS

This application claims the benefit of priority to as a continuation-in-part and incorporates herein by reference in its entirety for all purposes, U.S. patent application Ser. No. 11/207,595 entitled “METHOD FOR HIGH VOLTAGE POWER FEED ON DIFFERENTIAL CABLE PAIRS,” by John R. Camagna, et al. filed Aug. 19, 2005; and Ser. No. 11/207,602 entitled “A METHOD FOR DYNAMIC INSERTION LOSS CONTROL FOR 10/100/1000 MHZ ETHERNET SIGNALLING,” by John R. Camagna, et al. filed Aug. 19, 2005.

### BACKGROUND

Many networks such as local and wide area networks (LAN/WAN) structures are used to carry and distribute data communication signals between devices. Various network elements include hubs, switches, routers, and bridges, peripheral devices, such as, but not limited to, printers, data servers, desktop personal computers (PCs), portable PCs and personal data assistants (PDAs) equipped with network interface cards. Devices that connect to the network structure use power to enable operation. Power of the devices may be supplied by either an internal or an external power supply such as batteries or an AC power via a connection to an electrical outlet.

Some network solutions can distribute power over the network in combination with data communications. Power distribution over a network consolidates power and data communications over a single network connection to reduce installation costs, ensures power to network elements in the event of a traditional power failure, and enables reduction in the number of power cables, AC to DC adapters, and/or AC power supplies which may create fire and physical hazards. Additionally, power distributed over a network such as an Ethernet network may function as an uninterruptible power supply (UPS) to components or devices that normally would be powered using a dedicated UPS.

Additionally, network appliances, for example voice-over-Internet-Protocol (VOIP) telephones and other devices, are increasingly deployed and consume power. When compared to traditional counterparts, network appliances use an additional power feed. One drawback of VOIP telephony is that in the event of a power failure the ability to contact emergency services via an independently powered telephone is removed. The ability to distribute power to network appliances or circuits enable network appliances such as a VOIP telephone to operate in a fashion similar to ordinary analog telephone networks currently in use.

Distribution of power over Ethernet (PoE) network connections is in part governed by the Institute of Electrical and Electronics Engineers (IEEE) Standard 802.3 and other relevant standards, standards that are incorporated herein by reference. However, power distribution schemes within a network environment typically employ cumbersome, real estate intensive, magnetic transformers. Additionally, power-over-Ethernet (PoE) specifications under the IEEE 802.3 standard are stringent and often limit allowable power.

Various devices can only communicate with a network through an intermediate connection with a computer or similar system. Devices such as cameras, cam-corders, iPods™, storage devices, RFID tag readers, and many others cannot communicate directly with a network.

### SUMMARY

According to an embodiment of a network device, an Ethernet bridge module is integrated onto a single-chip integrated circuit. The Ethernet bridge module comprises a network connector integrated onto the Ethernet bridge module in a configuration that transfers power and communication signals, and at least one driver and/or transceiver integrated onto the Ethernet bridge module and configured to interface to at least one device external to the Ethernet bridge module. The Ethernet bridge module further comprises a Power-over-Ethernet (PoE) circuit integrated onto the Ethernet bridge module and coupled between the network connector and the at least one driver and/or transceiver.

### BRIEF DESCRIPTION OF THE DRAWINGS

Embodiments of the invention relating to both structure and method of operation may best be understood by referring to the following description and accompanying drawings:

FIGS. 1A and 1B are schematic block diagrams that respectively illustrate a high level example embodiments of client devices in which power is supplied separately to network attached client devices, and a switch that is a power supply equipment (PSE)-capable power-over Ethernet (PoE) enabled LAN switch that supplies both data and power signals to the client devices;

FIG. 2 is a functional block diagram illustrating a network interface including a network powered device (PD) interface and a network power supply equipment (PSE) interface, each implementing a non-magnetic transformer and choke circuitry;

FIGS. 3A and 3B are schematic block diagrams showing embodiments of a network device configured as an Ethernet bridge module;

FIG. 4 is a schematic block diagram depicting an embodiment of a network device in a configuration of an Ethernet bridge module that includes a magnetic transformer; and

FIG. 5 is a schematic block diagram showing an embodiment of a network device configured as an Ethernet bridge module contained within a housing.

### DETAILED DESCRIPTION

A bridge circuit can bridge from Ethernet to legacy interfaces including interfaces to devices that are not typically Ethernet-enabled. For example, the bridge circuit enables interfacing to Universal Serial Bus (USB), Firewire (i.Link or IEEE 1394), Recommended Standard (RS)-232 serial binary data, RS-485 high-speed serial, Peripheral Component Interconnect (PCI), CompactPCI (cPCI), other PCI variant, or other suitable digital interfaces.

In some embodiments, at a fundamental primary level the bridge circuit can comprise a transformer-less power over Ethernet interface in combination with a Media Access Control (MAC) element, a processor to form various tasks for usage by the bridge interface, and digital drivers for usage by legacy interfaces.

In further embodiments, the bridge circuit can extend to a further level by adding an analog interface with an analog transceiver so that information on the internet can communicate to the analog domain. For example, analog transceivers enable direct internet communication with devices such as a Home Phoneline Networking Alliance (HPNA), home personal connections, Institute of Electrical and Electronics Engineers (IEEE) 802.11 wireless standard, Wi-Fi standard, Radio Frequency Identification (RFID) tag ID readers, scanners, and other analog devices.

In various embodiments, an Ethernet bridge can support a power feed on multiple signal pairs. Some embodiments can be in the form of a connector, such as a Registered Jack (RJ)-45 connector, which include an integrated powered device (PD) controller, a DC-DC controller, and an Ethernet transformer. Other embodiments can be in the form of a connector, such as a Registered Jack (RJ)-45 connector, which include an integrated powered device (PD) controller, a DC-DC controller, and a solid-state transformer, such as a T-connect or T-Less Connect™ solid-state transformer.

The Ethernet bridge can be constructed with a T-LessConnect™ solid-state transformer or a magnetic transformer, and may be implemented as a single-chip application-based appliance. In some configurations, the Ethernet bridge circuit can be integrated onto one chip.

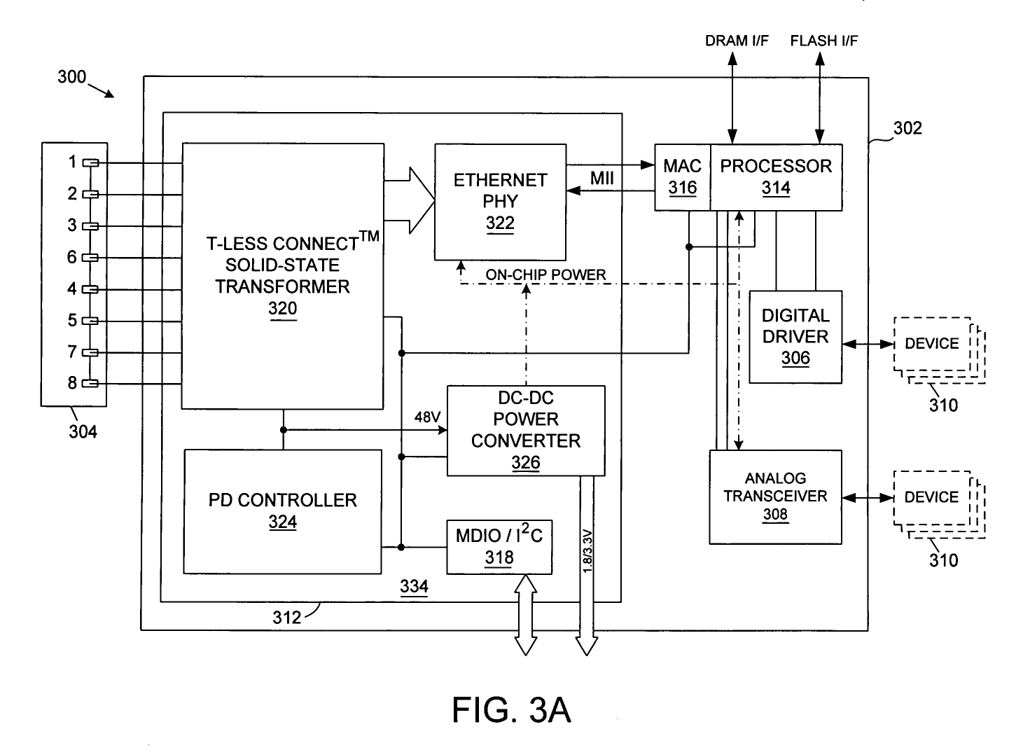

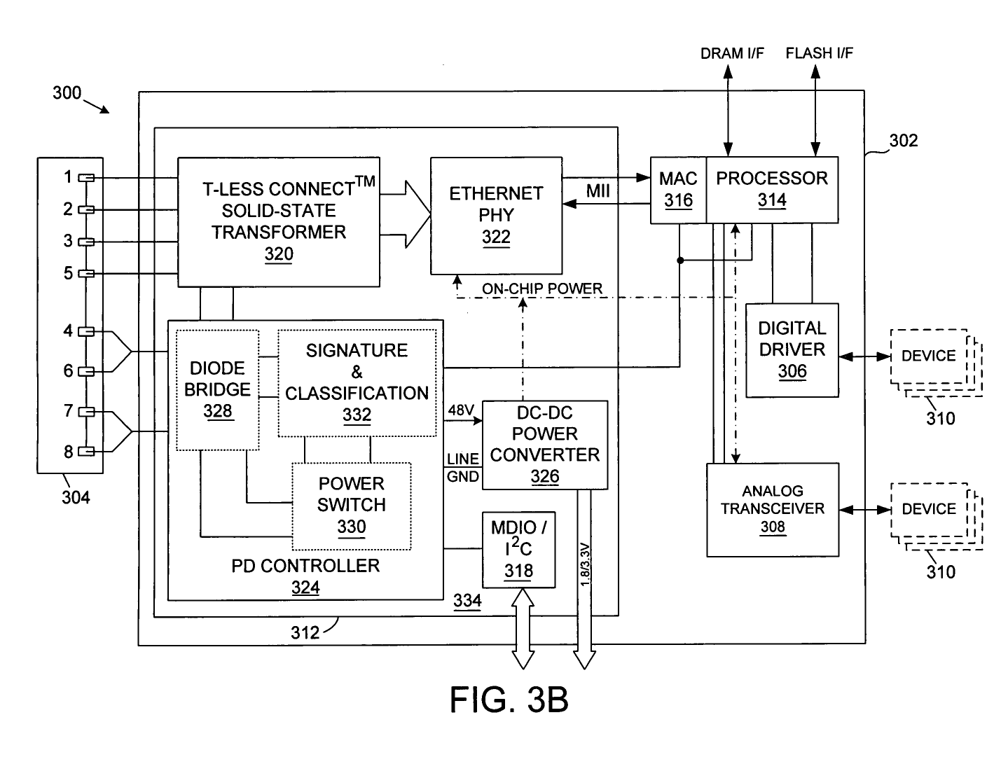

Referring to FIG. 3A, a schematic block diagram illustrates an embodiment of a network device 300 configured as an Ethernet bridge module 302. The Ethernet bridge module 302 can be integrated onto a single-chip integrated circuit. The Ethernet bridge module 302 comprises a network connector 304 coupled to the integrated Ethernet bridge module 302 in a configuration that transfers power and communication signals. The Ethernet bridge module 302 further comprises one or more drivers 306 and/or one or more transceivers 308 integrated onto the Ethernet bridge module 302 and configured to interface to one or more devices 310 external to the Ethernet bridge module 302. The Ethernet bridge module 302 further comprises a Power-over-Ethernet (PoE) circuit 312 integrated onto the Ethernet bridge module 302 and coupled between the network connector 304 and the drivers 306 and/or transceivers 308.

In some embodiments, the network connector 302 can be a Registered Jack (RJ) 45 physical interface and the drivers 306 and/or transceivers 308 can comprise a digital driver with one or more digital interfaces and/or an analog transceiver with one or more analog interfaces. Various embodiments can include one or more digital interfaces such as a digital driver for Universal Serial Bus (USB), a FireWire Institute of Electrical and Electronics Engineers (IEEE) 1394 serial bus interface standard driver, a Recommended Standard (RS)-232 serial binary data interface driver, a RS-485 high-speed serial interface driver, a Peripheral Component Interconnect (PCI) standard interface driver, a PCI variant interface driver, or other suitable digital interfaces. Various embodiments can include one or more analog interfaces such as a Home Phoneline Networking Alliance (HPNA) interface driver, an Institute of Electrical and Electronics Engineers (IEEE) 802.11 wireless standard interface driver, a Wi-Fi standard interface driver, a Radio Frequency Identification (RFID) reader interface driver, a scanner interface driver, or other suitable analog interfaces.

In an early phase implementation, analog transceivers 308 can be a CompactPCI interface, a USB interface, or other standard interface rather than an integrated transceiver. In a later phase, analog transceivers 308 can be integrated on one integrated circuit chip as a single-chip bridge appliance.

The illustrative network device 300 comprises a processor 314 integrated onto the Ethernet bridge module 302 that has functional programming for interfacing to memory, for example a dynamic random access memory (DRAM) interface, a flash memory interface, and the like, and for interfacing to the drivers 306 and/or transceivers 308. The processor 314 can include various programming to facilitate bridge interfacing such as stack processing, packet processing, forwarding, scheduling, rule-based processing, interface task monitoring, and the like.

The Ethernet bridge module 302 further can comprise a Media Access Control (MAC) layer 316 which is communicatively coupled to the processor 314 and functions as a controller to determine access to physical media. The MAC layer 316 executes various operations such as 802.3 MAC functions or modifications to HPNA, HPNA MAC, 802.11, 802.11 MAC, Ethernet, Ethernet MAC, and the like according to the particular application executed.

In typical embodiments, the processor 314 can be a microprocessor, a central processing unit (CPU), a digital signal processor, computational logic, state machine, and the like. The processor 314 can include functional programming selected from among functional modules such as a Transmission Control Protocol/Internet Protocol (TCP/IP) stack processing module, a packet processing module adapted for packet forwarding and scheduling, a rule based processing module, a monitoring and event scheduling module, a drivers module, and others.

The MAC layer 316 can include functional programming selected from among modules such as an Institute of Electrical and Electronics Engineers (IEEE) 802.3 physical layer and data link layer module, a IEEE 802.11 wireless module, a Home Phoneline Networking Alliance (HPNA) module, a Residential Internet (RI) module, and the like.

In some network device embodiments, a Management Data Input/Output (MDIO) and/or an Inter-Integrated Circuit (I²C) interface 318 can be integrated onto the Ethernet bridge module 302.

In the illustrative network device 302, the Power-over-Ethernet (PoE) circuit 312 comprises an integrated Powered Ethernet Device (iPED) 334. The iPED 334 comprises a non-magnetic transformer and choke circuit 320 that is integrated into the iPED 334 and coupled to communication signal pins of the network interface 304. The iPED 334 can further comprise an Ethernet physical layer (PHY) 322 that is integrated into the iPED 334 and coupled between the non-magnetic transformer and choke circuit 320 and the processor, a Powered Ethernet Device (PD) controller 324 integrated into the iPED 334 and coupled to power pins of the network interface 304, and a Direct Current-Direct Current (DC-DC) power converter 326 that is integrated into the iPED 334 and coupled between the PD controller 324 and the processor 314.

In some arrangements and configurations, the non-magnetic transformer and choke circuit 320 can be a T-Less Connect™ solid-state transformer. The T-Less Connect™ solid-state transformer separates Ethernet signals from power signals.

In some embodiments the T-Less Connect™ solid-state transformer can function by floating ground potential of the Ethernet PHY relative to earth ground.

Referring to FIG. 3B, a schematic block diagram illustrates an embodiment of a network device 300 configured as an Ethernet bridge module 302 that may be constructed as a single integrated circuit chip, multiple integrated circuits, a circuit board with multiple components and devices, or any other suitable arrangement. The illustrative Ethernet bridge module 302 comprises a network connector 304 in a configuration that transfers power and communication signals, one or more drivers 306 and/or transceivers 308 configured to interface to one or more devices 310 external to the Ethernet bridge module 302, and a Power-over-Ethernet (PoE) circuit 312 coupled between the network connector 304 and drivers 306 and/or transceivers 308 and comprising an integrated Powered Ethernet Device (iPED) 334.

In the illustrative arrangement, the iPED 334 comprises a non-magnetic transformer and choke circuit 320, an Ethernet physical layer (PHY) 322, a Powered Ethernet Device (PD) controller 324, and a Direct Current-Direct Current (DC-DC) power converter 326. The non-magnetic transformer and choke circuit 320 is a non-magnetic transformer and choke circuit 320 integrated into the iPED 334 and connected to communication signal pins of the network interface 304. The Ethernet physical layer (PHY) 322 is integrated into the iPED 334 and connected to the non-magnetic transformer and choke circuit 320. The Powered Ethernet Device (PD) controller 324 is integrated into the iPED 334 and connected to power pins of the network interface 304. The Direct Current-Direct Current (DC-DC) power converter 326 integrated into the iPED 334 and connected to the PD controller 324.

FIG. 3B shows the Powered Ethernet Device (PD) controller 324 in greater detail. The illustrative PD controller 324 comprises a diode bridge 328 coupled to power pins of the network interface 304, a power switch circuit 330 coupled to the diode bridge 328, and a signature and classification circuit 332 coupled to the diode bridge 328 and the power switch circuit 330.

The non-magnetic transformer and choke circuit 320 depicted in FIG. 3B can also be a T-Less Connect™ solid-state transformer that separates Ethernet signals from power signals and/or that operates by floating ground potential of the Ethernet PHY relative to earth ground.

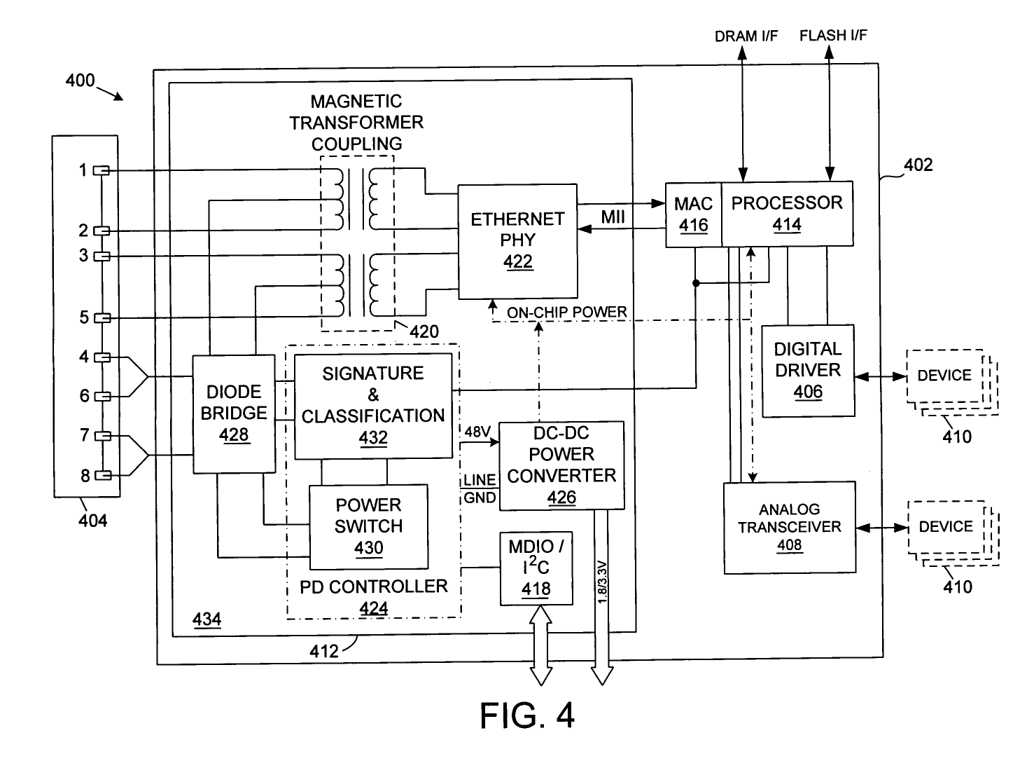

Referring to FIG. 4, a schematic block diagram depicts an embodiment of a network device 400 in a configuration of an Ethernet bridge module 402 that includes a magnetic transformer 420. The illustrative Ethernet bridge module 402 comprises a network connector 404 in a configuration that transfers power and communication signals, one or more drivers 406 and/or transceivers 408 configured to interface to devices 410 external to the Ethernet bridge module 402, and a Power-over-Ethernet (PoE) circuit 412 coupled between the network connector 404 and drivers 406 and/or transceivers 408. The illustrative POE circuit 412 comprises a magnetic transformer 420 coupled to communication signal pins of the network interface 404, an Ethernet physical layer (PHY) 422 coupled to the magnetic transformer 420, a Powered Ethernet Device (PD) controller 424 coupled to power pins of the network interface 404, and a Direct Current-Direct Current (DC-DC) power converter 426 coupled to the PD controller 424.

An illustrative Power-over-Ethernet (PoE) circuit 412 comprises a magnetic transformer 420 coupled to communication signal pins of a network interface 404. An Ethernet physical layer (PHY) 422 is coupled between the magnetic transformer 420 and a processor 414. A Powered Ethernet Device (PD) controller 424 can be coupled to power pins of the network interface 404. The PoE circuit 412 also can have a Direct Current-Direct Current (DC-DC) power converter 426 coupled between the PD controller 424 and the processor 414.

In the illustrative network device 400, the Power-over-Ethernet (PoE) circuit 412 further comprises a diode bridge 428 coupled between power pins of the network interface 404 and the PD controller 424.

The Powered Ethernet Device (PD) controller 424 can comprise a power switch circuit 430 and a signature and classification circuit 432.

In some embodiments, the Ethernet bridge module 402 can be integrated onto a single-chip integrated circuit.

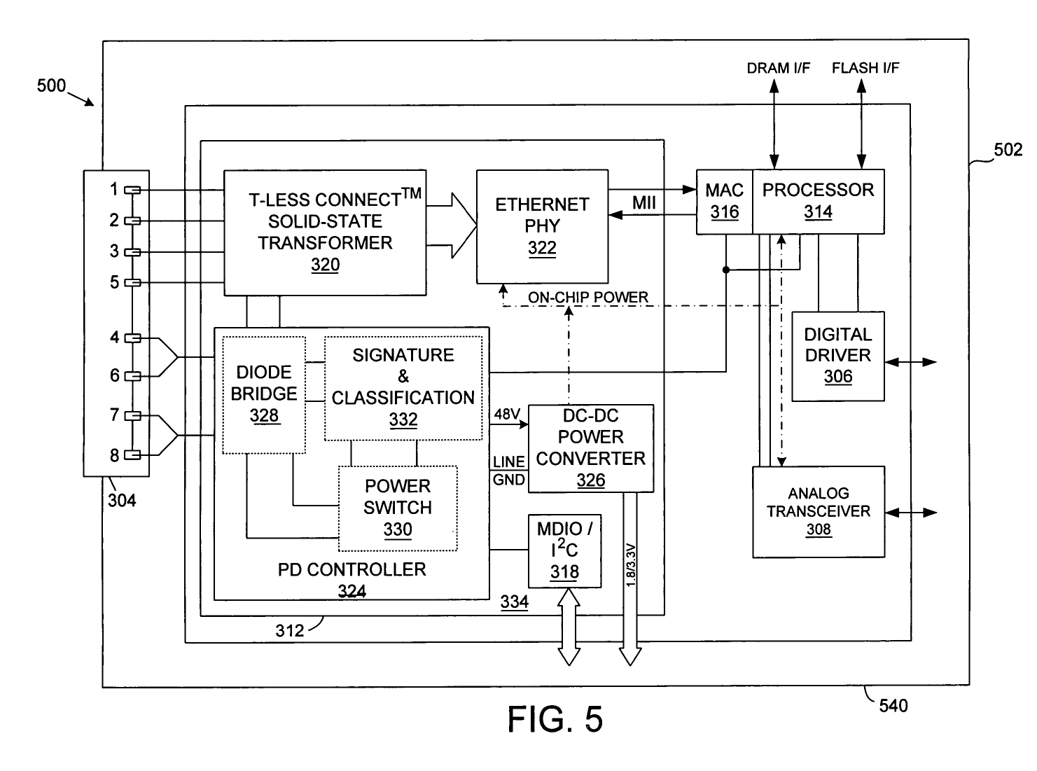

Referring to FIG. 5, a schematic block diagram shows an embodiment of a network device 500 configured as an Ethernet bridge module 502 that comprises a housing 540, a network connector 304 coupled to the housing 540 and configured to transfers power and communication signals, and one or more drivers 306 and/or transceivers 308. The drivers 306 and/or transceivers 308 are contained in the housing 540 and configured to interface to devices external to the Ethernet bridge module 502. The devices are selectable from among Ethernet-enabled devices and Ethernet non-enabled devices. The Ethernet bridge module 502 further comprises a Power-over-Ethernet (PoE) circuit 312 contained in the housing 540 and coupled between the network connector 304 and the drivers 306 and/or transceivers 308.

The illustrative Ethernet bridge arrangement 502 enables internet communication with various standard and legacy interfaces and/or devices that may or may not be Ethernet enabled. For example, the Ethernet bridge 502 enables direct connection from the internet to a USB interface—a local interface that connects to common devices such as computers, printers, scanners, cameras, cam-corders, and the like. The Ethernet bridge 502 enables image and other data from a camera or cam-corder to pass directly from the device onto a network by email or other technique by either wired or wireless Ethernet transmission. The Ethernet bridge 502 enables a device such as a digital camera to mount essentially directly on the Ethernet interface, for example via the USB interface, and send data simply and seamlessly across to a selected receiver on the network.

In another example, one device that has a USB interface but not direct Ethernet connection, for example an iPod™, can also be connected directly to Ethernet without passing through a computer through usage of the Ethernet bridge 502. Accordingly, if a network is available, the Ethernet bridge 502 can be used to plug the iPod into the network so that anyone with access to the network can listen to music played on the iPod. The music can be piped essentially to any location via the network.

Similarly, the Ethernet bridge 502 can have a Firewire (IEEE 1394) analog transceiver 308 that enables connection of a cam-corder to Ethernet and communication via a streaming protocol. The Ethernet connection formed by the Ethernet bridge 502 extends the communication distance for Firewire transmission.

The Ethernet bridge 502 further enables direct connection of an RS-232 interface to an Ethernet connection box so that data can pass directly from a source to the internet without requiring passage through an intervening computer. Accordingly, the Ethernet bridge 502, by enabling direct connection of RS-232 to Ethernet, greatly facilitates network connectivity by virtue of the ubiquitous availability of RS-232 interfaces.

In an illustrative embodiment, the housing 540 can be configured as a very small dongle containing a small integrated circuit chip embodying the Ethernet bridge circuit 502. The housing 540 can be positioned at one end of an Ethernet cable with the opposing end configured as an RJ-45 male jack 304. Information passes through the Ethernet bridge 502 from the network connector 304 to, for example, a USB port, RS-232 port, or the like. The network device 500 enables direct connection of various legacy devices to the network for monitoring and communication of information to virtually any location.

The IEEE 802.3 Ethernet Standard, which is incorporated herein by reference, addresses loop powering of remote Ethernet devices (802.3af). Power over Ethernet (PoE) standard and other similar standards support standardization of power delivery over Ethernet network cables to power remote client devices through the network connection. The side of link that supplies power is called Powered Supply Equipment (PSE). The side of link that receives power is the Powered device (PD). Other implementations may supply power to network attached devices over alternative networks such as, for example, Home Phoneline Networking alliance (HomePNA) local area networks and other similar networks. HomePNA uses existing telephone wires to share a single network connection within a home or building. In other examples, devices may support communication of network data signals over power lines.

In various configurations described herein, a magnetic transformer of conventional systems may be eliminated while transformer functionality is maintained. Techniques enabling replacement of the transformer may be implemented in the form of integrated circuits (ICs) or discrete components.

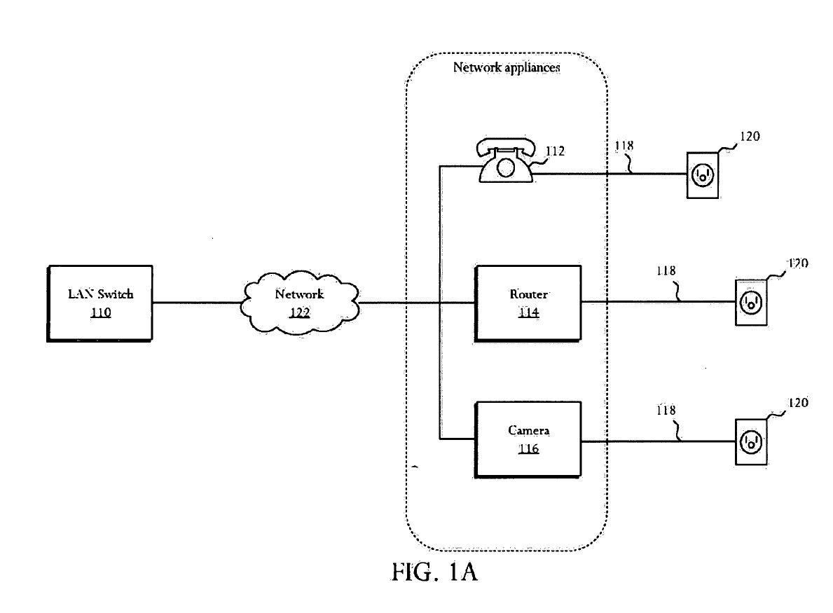

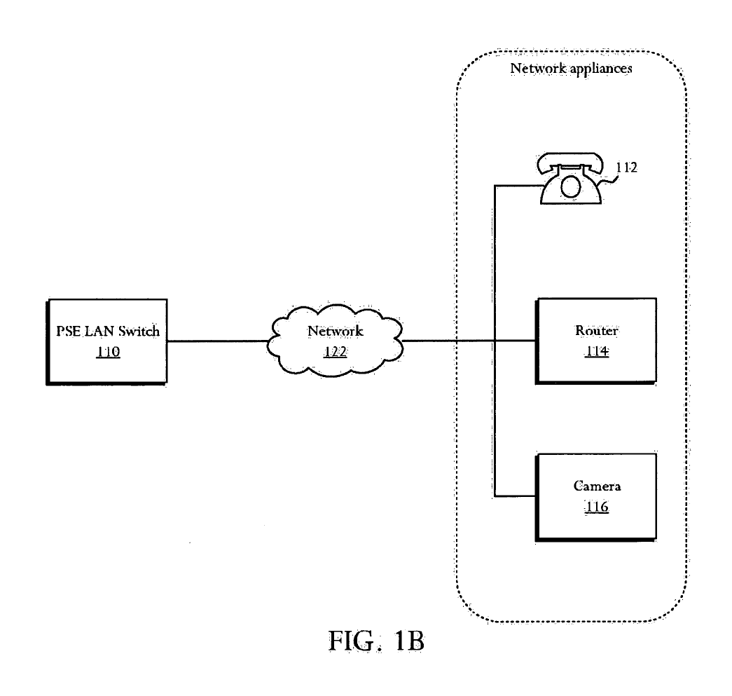

FIG. 1A is a schematic block diagram that illustrates a high level example embodiment of devices in which power is supplied separately to network attached client devices 112 through 116 that may benefit from receiving power and data via the network connection. The devices are serviced by a local area network (LAN) switch 110 for data. Individual client devices 112 through 116 have separate power connections 118 to electrical outlets 120. FIG. 1B is a schematic block diagram that depicts a high level example embodiment of devices wherein a switch 110 is a power supply equipment (PSE)-capable power-over Ethernet (PoE) enabled LAN switch that supplies both data and power signals to client devices 112 through 116. Network attached devices may include a Voice Over Internet Protocol (VOIP) telephone 112, access points, routers, gateways 114 and/or security cameras 116, as well as other known network appliances. Network supplied power enables client devices 112 through 116 to eliminate power connections 118 to electrical outlets 120 as shown in FIG. 1A. Eliminating the second connection enables the network attached device to have greater reliability when attached to the network with reduced cost and facilitated deployment.

Although the description herein may focus and describe a system and method for coupling high bandwidth data signals and power distribution between the integrated circuit and cable that uses transformer-less ICs with particular detail to the IEEE 802.3af Ethernet standard, the concepts may be applied in non-Ethernet applications and non-IEEE 802.3af applications. Also, the concepts may be applied in subsequent standards that supersede or complement the IEEE 802.3af standard.

Various embodiments of the depicted system may support solid-state, and thus non-magnetic, transformer circuits operable to couple high bandwidth data signals and power signals with new mixed-signal IC technology, enabling elimination of cumbersome, real-estate intensive magnetic-based transformers.

Typical conventional communication systems use transformers to perform common mode signal blocking, 1500 volt isolation, and AC coupling of a differential signature as well as residual lightning or electromagnetic shock protection. The functions are replaced by a solid state or other similar circuits in accordance with embodiments of circuits and systems described herein whereby the circuit may couple directly to the line and provide high differential impedance and low common mode impedance. High differential impedance enables separation of the physical layer (PHY) signal from the power signal. Low common mode impedance enables elimination of a choke, allowing power to be tapped from the line. The local ground plane may float to eliminate a requirement for 1500 volt isolation. Additionally, through a combination of circuit techniques and lightning protection circuitry, voltage spike or lightning protection can be supplied to the network attached device, eliminating another function performed by transformers in traditional systems or arrangements. The disclosed technology may be applied anywhere transformers are used and is not limited to Ethernet applications.

Specific embodiments of the circuits and systems disclosed herein may be applied to various powered network attached devices or Ethernet network appliances. Such appliances include, but are not limited to VoIP telephones, routers, printers, and other similar devices.

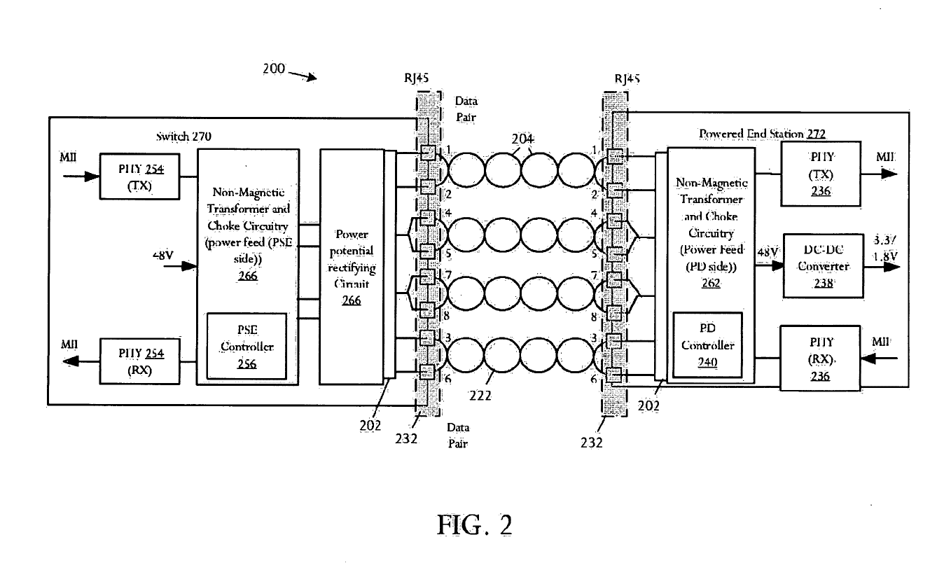

Referring to FIG. 2, a functional block diagram depicts an embodiment of a network device 200 including a T-Less Connect™ solid-state transformer. The illustrative network device comprises a power potential rectifier 202 adapted to conductively couple a network connector 232 to an integrated circuit 270, 272 that rectifies and passes a power signal and data signal received from the network connector 232. The power potential rectifier 202 regulates a received power and/or data signal to ensure proper signal polarity is applied to the integrated circuit 270, 272.

The network device 200 is shown with the power sourcing switch 270 sourcing power through lines 1 and 2 of the network connector 232 in combination with lines 3 and 6.

In some embodiments, the power potential rectifier 202 is configured to couple directly to lines of the network connector 232 and regulate the power signal whereby the power potential rectifier 202 passes the data signal with substantially no degradation.

In some configuration embodiments, the network connector 232 receives multiple twisted pair conductors 204, for example twisted 22-26 gauge wire. Any one of a subset of the twisted pair conductors 204 can forward bias to deliver current and the power potential rectifier 202 can forward bias a return current path via a remaining conductor of the subset.

FIG. 2 illustrates the network interface 200 including a network powered device (PD) interface and a network power supply equipment (PSE) interface, each implementing a non-magnetic transformer and choke circuitry. A powered end station 272 is a network interface that includes a network connector 232, non-magnetic transformer and choke power feed circuitry 262, a network physical layer 236, and a power converter 238. Functionality of a magnetic transformer is replaced by circuitry 262. In the context of an Ethernet network interface, network connector 232 may be a RJ45 connector that is operable to receive multiple twisted wire pairs. Protection and conditioning circuitry may be located between network connector 232 and non-magnetic transformer and choke power feed circuitry 262 to attain surge protection in the form of voltage spike protection, lighting protection, external shock protection or other similar active functions. Conditioning circuitry may be a diode bridge or other rectifying component or device. A bridge or rectifier may couple to individual conductive lines 1-8 contained within the RJ45 connector. The circuits may be discrete components or an integrated circuit within non-magnetic transformer and choke power feed circuitry 262.

In an Ethernet application, the IEEE 802.3af standard (PoE standard) enables delivery of power over Ethernet cables to remotely power devices. The portion of the connection that receives the power may be referred to as the powered device (PD). The side of the link that supplies power is called the power sourcing equipment (PSE).

In the powered end station 272, conductors 1 through 8 of the network connector 232 couple to non-magnetic transformer and choke power feed circuitry 262. Non-magnetic transformer and choke power feed circuitry 262 may use the power feed circuit and separate the data signal portion from the power signal portion. The data signal portion may then be passed to the network physical layer (PHY) 236 while the power signal passes to power converter 238.

If the powered end station 272 is used to couple the network attached device or PD to an Ethernet network, network physical layer 236 may be operable to implement the 10 Mbps, 100 Mbps, and/or 1 Gbps physical layer functions as well as other Ethernet data protocols that may arise. The Ethernet PHY 236 may additionally couple to an Ethernet media access controller (MAC). The Ethernet PHY 236 and Ethernet MAC when coupled are operable to implement the hardware layers of an Ethernet protocol stack. The architecture may also be applied to other networks. If a power signal is not received but a traditional, non-power Ethernet signal is received the nonmagnetic power feed circuitry 262 still passes the data signal to the network PHY.

The power signal separated from the network signal within non-magnetic transformer and choke power feed circuit 262 by the power feed circuit is supplied to power converter 238. Typically the power signal received does not exceed 57 volts SELV (Safety Extra Low Voltage). Typical voltage in an Ethernet application is 48-volt power. Power converter 238 may then further transform the power as a DC to DC converter to provide 1.8 to 3.3 volts, or other voltages specified by many Ethernet network attached devices.

Power-sourcing switch 270 includes a network connector 232, Ethernet or network physical layer 254, PSE controller 256, non-magnetic transformer and choke power supply circuitry 266, and possibly a multiple-port switch. Transformer functionality is supplied by non-magnetic transformer and choke power supply circuitry 266. Power-sourcing switch 270 may be used to supply power to network attached devices. Powered end station 272 and power sourcing switch 270 may be applied to an Ethernet application or other network-based applications such as, but not limited to, a vehicle-based network such as those found in an automobile, aircraft, mass transit system, or other like vehicle. Examples of specific vehicle-based networks may include a local interconnect network (LIN), a controller area network (CAN), or a flex ray network. All may be applied specifically to automotive networks for the distribution of power and data within the automobile to various monitoring circuits or for the distribution and powering of entertainment devices, such as entertainment systems, video and audio entertainment systems often found in today's vehicles. Other networks may include a high speed data network, low speed data network, time-triggered communication on CAN (TTCAN) network, a J11939-compliant network, ISO11898-compliant network, an ISO11519-2-compliant network, as well as other similar networks. Other embodiments may supply power to network attached devices over alternative networks such as but not limited to a HomePNA local area network and other similar networks. HomePNA uses existing telephone wires to share a single network connection within a home or building. Alternatively, embodiments may be applied where network data signals are provided over power lines.

Non-magnetic transformer and choke power feed circuitry 262 and 266 enable elimination of magnetic transformers with integrated system solutions that enable an increase in system density by replacing magnetic transformers with solid state power feed circuitry in the form of an integrated circuit or discreet component.

In some embodiments, non-magnetic transformer and choke power feed circuitry 262, network physical layer 236, power distribution management circuitry 254, and power converter 238 may be integrated into a single integrated circuit rather than discrete components at the printed circuit board level. Optional protection and power conditioning circuitry may be used to interface the integrated circuit to the network connector 232.

The Ethernet PHY may support the 10/100/1000 Mbps data rate and other future data networks such as a 10000 Mbps Ethernet network. Non-magnetic transformer and choke power feed circuitry 262 supplies line power minus the insertion loss directly to power converter 238, converting power first to a 12V supply then subsequently to lower supply levels. The circuit may be implemented in any appropriate process, for example a 0.18 or 0.13 micron process or any suitable size process.

Non-magnetic transformer and choke power feed circuitry 262 may implement functions including IEEE 802.3.af signaling and load compliance, local unregulated supply generation with surge current protection, and signal transfer between the line and integrated Ethernet PHY. Since devices are directly connected to the line, the circuit may be implemented to withstand a secondary lightning surge.

For the power over Ethernet (PoE) to be IEEE 802.3af standard compliant, the PoE may be configured to accept power with various power feeding schemes and handle power polarity reversal. A rectifier, such as a diode bridge, a switching network, or other circuit, may be implemented to ensure power signals having an appropriate polarity are delivered to nodes of the power feed circuit. Any one of the conductors 1, 4, 7 or 3 of the network RJ45 connection can forward bias to deliver current and any one of the return diodes connected can forward bias to form a return current path via one of the remaining conductors. Conductors 2, 5, 8 and 4 are connected similarly.

Non-magnetic transformer and choke power feed circuitry 262 applied to PSE may take the form of a single or multiple port switch to supply power to single or multiple devices attached to the network. Power sourcing switch 270 may be operable to receive power and data signals and combine to communicate power signals which are then distributed via an attached network. If power sourcing switch 270 is a gateway or router, a high-speed uplink couples to a network such as an Ethernet network or other network. The data signal is relayed via network PHY 254 and supplied to non-magnetic transformer and choke power feed circuitry 266. PSE switch 270 may be attached to an AC power supply or other internal or external power supply to supply a power signal to be distributed to network-attached devices that couple to power sourcing switch 270. Power controller 256 within or coupled to non-magnetic transformer and choke power feed circuitry 266 may determine, in accordance with IEEE standard 802.3af, whether a network-attached device in the case of an Ethernet network-attached device is a device operable to receive power from power supply equipment. When determined that an IEEE 802.3af compliant powered device (PD) is attached to the network, power controller 256 may supply power from power supply to non-magnetic transformer and choke power feed circuitry 266, which is sent to the downstream network-attached device through network connectors, which in the case of the Ethernet network may be an RJ45 receptacle and cable.

IEEE 802.3af Standard is to fully comply with existing non-line powered Ethernet network systems. Accordingly, PSE detects via a well-defined procedure whether the far end is PoE compliant and classify sufficient power prior to applying power to the system. Maximum allowed voltage is 57 volts for compliance with SELV (Safety Extra Low Voltage) limits.

For backward compatibility with non-powered systems, applied DC voltage begins at a very low voltage and only begins to deliver power after confirmation that a PoE device is present. In the classification phase, the PSE applies a voltage between 14.5V and 20.5V, measures the current and determines the power class of the device. In one embodiment the current signature is applied for voltages above 12.5V and below 23 Volts. Current signature range is 0-44 mA.

The normal powering mode is switched on when the PSE voltage crosses 42 Volts where power MOSFETs are enabled and the large bypass capacitor begins to charge.

A maintain power signature is applied in the PoE signature block—a minimum of 10 mA and a maximum of 23.5 kohms may be applied for the PSE to continue to feed power. The maximum current allowed is limited by the power class of the device (class 0-3 are defined). For class 0, 12.95 W is the maximum power dissipation allowed and 400 ma is the maximum peak current. Once activated, the PoE will shut down if the applied voltage falls below 30V and disconnect the power MOSFETs from the line.

Power feed devices in normal power mode provide a differential open circuit at the Ethernet signal frequencies and a differential short at lower frequencies. The common mode circuit presents the capacitive and power management load at frequencies determined by the gate control circuit.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, component values, integrated circuit process variations, temperature variations, rise and fall times, and/or thermal noise. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. For example, various aspects or portions of a network interface are described including several optional implementations for particular portions. Any suitable combination or permutation of the disclosed designs may be implemented.

What is claimed is:

1. A network device comprising:
an Ethernet bridge module integrated onto a single-chip integrated circuit comprising:
a network connector coupled to an integrated Ethernet bridge module in a configuration that transfers power and communication signals;
at least one driver and/or transceiver integrated onto the Ethernet bridge module and configured to interface to at least one device external to the Ethernet bridge module; and
a Power-over-Ethernet (PoE) circuit integrated onto the Ethernet bridge module and coupled between the network connector and the at least one driver and/or transceiver.

2. The network device according to claim 1 further comprising:
the network connector comprising a Registered Jack (RJ) 45 physical interface; and
the at least one driver and/or transceiver comprising:
a digital driver comprising at least one digital interface; and
an analog transceiver comprising at least one analog interface.

3. The network device according to claim 2 wherein the at least one digital interface is selected from a group of digital interfaces consisting of:
a digital driver for Universal Serial Bus (USB);
a FireWire Institute of Electrical and Electronics Engineers (IEEE) 1394 serial bus interface standard driver;
a Recommended Standard (RS)-232 serial binary data interface driver;
a RS-485 high-speed serial interface driver;
a Peripheral Component Interconnect (PCI) standard interface driver;
a PCI variant interface driver.

4. The network device according to claim 2 wherein the at least one analog interface is selected from a group of analog interfaces consisting of:
a Home Phoneline Networking Alliance (HPNA) interface driver;
an Institute of Electrical and Electronics Engineers (IEEE) 802.11 wireless standard interface driver;
a Wi-Fi standard interface driver;
a Radio Frequency Identification (RFID) reader interface driver; and
a scanner interface driver.

5. The network device according to claim 1 further comprising:
a processor integrated onto the Ethernet bridge module and comprising functional programming configured for interfacing to memory and for interfacing to the at least one driver and/or transceiver; and
a Media Access Control (MAC) layer communicatively coupled to the processor and comprising a controller to determine access to physical media.

6. The network device according to claim 5 further comprising:
the processor functional programming comprising at least one functional module selected from a group consisting of a Transmission Control Protocol/Internet Protocol (TCP/IP) stack processing module, a packet processing module adapted for packet forwarding and scheduling, a rule based processing module, a monitoring and event scheduling module, and a drivers module; and
the MAC layer comprising at least one functional module selected from a group consisting of an Institute of Electrical and Electronics Engineers (IEEE) 802.3 physical layer and data link layer module, an IEEE 802.11 wireless module, a Home Phoneline Networking Alliance (HPNA) module, a Residential Internet (RI) module.

7. The network device according to claim 5 further comprising:
a Management Data Input/Output (MDIO) and/or an Inter-Integrated Circuit (I²C) interface integrated onto the Ethernet bridge module.

8. The network device according to claim 1 further comprising:
the Power-over-Ethernet (PoE) circuit comprising:
a magnetic transformer coupled to communication signal pins of the network interface;
an Ethernet physical layer (PHY) coupled between the magnetic transformer and the processor;
a Powered Ethernet Device (PD) controller coupled to power pins of the network interface; and
a Direct Current-Direct Current (DC-DC) power converter coupled between the PD controller and the processor.

9. The network device according to claim 8 further comprising:
the Power-over-Ethernet (PoE) circuit further comprising:
a diode bridge coupled between power pins of the network interface and the PD controller.

10. The network device according to claim 8 further comprising:
the Powered Ethernet Device (PD) controller comprising a power switch circuit and a signature and classification circuit.

11. The network device according to claim 1 further comprising:
the Power-over-Ethernet (PoE) circuit comprising:
an integrated Powered Ethernet Device (iPED) comprising:
a non-magnetic transformer and choke circuit integrated into the iPED and coupled to communication signal pins of the network interface;
an Ethernet physical layer (PHY) integrated into the iPED and coupled between the non-magnetic transformer and choke circuit and the processor;
a Powered Ethernet Device (PD) controller integrated into the iPED and coupled to power pins of the network interface; and
a Direct Current-Direct Current (DC-DC) power converter integrated into the iPED and coupled between the PD controller and power pins of the processor.

12. The network device according to claim 11 further comprising:
the Powered Ethernet Device (PD) controller comprising:
a diode bridge coupled to power pins of the network interface;
a power switch circuit coupled to the diode bridge; and
a signature and classification circuit coupled to the diode bridge and the power switch circuit.

13. The network device according to claim 11 further comprising:
the integrated Powered Ethernet Device (iPED) further comprises a T-Less Connect™ solid-state transformer that separates Ethernet signals from power signals.

14. The network device according to claim 11 further comprising:
the integrated Powered Ethernet Device (iPED) further comprises a T-Less Connect™ solid-state transformer that floats ground potential of the Ethernet PHY relative to earth ground.

15. A network device comprising:
an Ethernet bridge module comprising:
a network connector in a configuration that transfers power and communication signals;
at least one driver and/or transceiver configured to interface to at least one device external to the Ethernet bridge module; and
a Power-over-Ethernet (PoE) circuit coupled between the network connector and the at least one driver and/or transceiver, the POE circuit comprising:
a magnetic transformer coupled to communication signal pins of the network interface;
an Ethernet physical layer (PHY) coupled to the magnetic transformer;
a Powered Ethernet Device (PD) controller coupled to power pins of the network interface; and
a Direct Current-Direct Current (DC-DC) power converter coupled to the PD controller.

16. The network device according to claim 15 further comprising:
the Power-over-Ethernet (PoE) circuit further comprising:
a diode bridge coupled between power pins of the network interface and the PD controller.

17. The network device according to claim 15 further comprising:
the Powered Ethernet Device (PD) controller comprising a power switch circuit and a signature and classification circuit.

18. The network device according to claim 15 further comprising:
the Ethernet bridge module integrated onto a single-chip integrated circuit.

19. A network device comprising:
an Ethernet bridge module comprising:
a network connector in a configuration that transfers power and communication signals;
at least one driver and/or transceiver configured to interface to at least one device external to the Ethernet bridge module; and
a Power-over-Ethernet (PoE) circuit coupled between the network connector and the at least one driver and/or transceiver, the POE circuit comprising:
an integrated Powered Ethernet Device (iPED) comprising:
a non-magnetic transformer and choke circuit integrated into the iPED and coupled to communication signal pins of the network interface;
an Ethernet physical layer (PHY) integrated into the iPED and coupled to the non-magnetic transformer and choke circuit;
a Powered Ethernet Device (PD) controller integrated into the iPED and coupled to power pins of the network interface; and
a Direct Current-Direct Current (DC-DC) power converter integrated into the iPED and coupled to the PD controller.

20. The network device according to claim 19 further comprising:
the Powered Ethernet Device (PD) controller comprising:
a diode bridge coupled to power pins of the network interface;
a power switch circuit coupled to the diode bridge; and
a signature and classification circuit coupled to the diode bridge and the power switch circuit.

21. The network device according to claim 19 further comprising:
the integrated Powered Ethernet Device (iPED) further comprises a T-Less Connect™ solid-state transformer that separates Ethernet signals from power signals.

22. The network device according to claim 19 further comprising:
the integrated Powered Ethernet Device (iPED) further comprises a T-Less Connect™ solid-state transformer that floats ground potential of the Ethernet PHY relative to earth ground.

23. The network device according to claim 19 further comprising:
the Ethernet bridge module integrated onto a single-chip integrated circuit.

24. A network device comprising:
an Ethernet bridge module comprising:
a housing;
a network connector coupled to the housing and configured to transfers power and communication signals;
at least one driver and/or transceiver contained in the housing and configured to interface to at least one device external to the Ethernet bridge module, the at least one device selectable from among Ethernet-enabled devices and Ethernet non-enabled devices; and
a Power-over-Ethernet (PoE) circuit contained in the housing and coupled between the network connector and the at least one driver and/or transceiver.
